(19) United States
(12) Patent Application Publication
(10) Pub. No.: US 2005/0003759 A1
(43) Pub. Date: Jan. 6, 2005

(54) Anonymous communication device

(76) Inventor: Kenneth A. Alley, Berwick, PA (US)

Correspondence Address: LAW OFFICES OF MARK A. GARZIA, P.C., 2058 CHICHESTER AVE, BOOTHWYN, PA, 19061, US

(21) Appl. No.: 10/871,714

(22) Filed: Jun. 18, 2004

Related U.S. Application Data
(60) Provisional application No. 60/479,790, filed on Jun. 19, 2003.

(51) Int. Cl. H04M 3/00

(52) U.S. Cl. 455/41.2; 455/550.1

(57) ABSTRACT

The aforementioned claims are intended to be general in nature and discuss principles on which this invention is based (and which this petition attempts to secure as original); no attempt to fix specific parameters (such as carrier frequencies or modulation schemes, to cite a non-exhaustive example) is made herein. Although the current petition may describe a preferred embodiment of the ACD, that should not be construed as an exhaustive description of implementation of the aforementioned principles. Those skilled in the art should be able to utilize accepted practices and construct said devices utilizing the principles detailed herein in more than one ways. The present invention utilizes multiple frequencies and wavelengths of the electromagnetic spectrum. The Anonymous Communication Device utilizes one part of the electromagnetic spectrum for alerting about its presence and physically targeting a second device (infra red) and uses RF to communicate with the target device, thus providing a personal communication device that has the ability to target, suitably modulate its RF carrier to match the targeted device, lock onto a second device and communicate (with any other device that has the same technology).

### CROSS REFERENCE TO RELATED APPLICATIONS

The present application claims the benefits under 35 U.S.C. §119(e) of U.S. Provisional Application No. 60/479,790 filed Jun. 19, 2003, titled ANONYMOUS COMMUNICATION DEVICE TECHNOLOGY (ACDT) in the name of Kenneth A. Alley.

U.S. Provisional Application No. 60/479,790 filed Jun. 19, 2003, is hereby incorporated by reference as if fully set forth herein.

### FIELD OF THE INVENTION

The present invention relates generally to wireless communication systems and in particular, to a novel, communication system that in which one communication device can target another communication device anonymously (i.e., without knowing the other device's telephone number, e-mail address, etc.).

### BACKGROUND OF THE INVENTION

There are numerous communication devices on the market today. These devices include cellular phones, PDA's, computers and many other networking technologies. Most existing wireless devices, such as cellular phones, PDA's, computers, etc-., all require service contracts and in =order to access or communicate with a secondary device the user must have the identification code (phone number, email address) of the other device (there are some exceptions to this general rule, such as “WiFi,” but they are short-range in general). Two-way radios (Walkie Talkies) do not require service contracts; they are set to predetermined frequencies that allow two a-like devices to communicate.

There are also remote control devices that allow the users to point at electronic devices to wirelessly control such devices (televisions, garage door openers, gates, etc), but those generally facilitate only one-way communication from a controller to a targeted device. It is commonplace today to find numerous devices that use either RF or Infra Red technologies to operate electro-mechanical equipment.

All of these existing communication devices require an identification code such as an email address or phone number to communicate with a specific/another device. Others are preprogrammed to communicate with a specific device or they have specific limited functions such as changing a TV remote.

The present invention (ACD) provides means to communicate anonymously with any other device without knowing an identification code or without requiring a service contract. Such a device would provide a new form of voice and text communication.

### SUMMARY OF THE INVENTION

The present invention is an Anonymous Communication Device (ACD). The ACD may be a handheld device that consists of an optical and/or mechanical targeting system. The targeting system may rely on frequencies in the infrared frequencies. The ACD will also consist of employ a RF transmitter and receiver. Although, unlike a standard two way radio, the ACD will communicate with an Infra red signal in-order to modulate the targeting devices radio frequency to that of the targeted ACD radio frequency.

Each ACD will provide a Beacon Signal allowing it to be targeted for voice and or text communication. The Beacon Signal, maybe continuous or only activated when the specific ACD is targeted, thus saving power. An important part of the ACD is the handshake between the targeting and targeted device and the selection of a suitable Rf carrier and modulation. This scheme would be different than the one utilized in the current 802.11 standards (commonly referred to as “WiFi”). In the case of WiFi, wireless access points each transmit at a channel arranged so that there is minimal interference with other access points; a device with a suitable transceiver may select one channel out of several, which may be available, to communicate with the access point assigned to it. In the case of the current invention, however, the targeting device, aware of what other channels and modulation schemes are used around it, will offer the targeted device suitable choices, which may encoded in the infrared beam which stimulates the targeted device. In turn, the targeted device, aware of what channels and modulation schemes are used around it and are thus occupied (which may be different than the ones the targeting device is aware of), will start transmitting on the options offered by the targeting device which are not occupied. The targeting device will then pick the channel and modulation scheme best suited for the RF link. Because of expected reciprocity, that choice may be the optimum for the given link. During the whole communication session, each ACD device is aware of whether it was the initiator of the communication or the target. If link conditions deteriorate, this handshaking scheme can be repeated, with either device transmitting a “repeat handshake” command. The device which was the initiator retransmits a list of available options (this time on the existing—and deteriorating RF link), etc., and the handshake is repeated. Thus, the two devices can dynamically renegotiate the channel and/or modulation as the link conditions change, without affecting other such communications.

The present invention, therefore, provides the user means to anonymously target any other ACD within its infrared range and or visual range. Once locking onto the targeted ACD, both devices may then communicate via voice or text by means of their built-in RF transmitter/receiver. As long as both ACD'S remain within RF range (predetermined by the each unit's power, modulation, and propagation path between the two units), they can communicate.

The Anonymous Communication Technology (ACT) has multiple applications and may be adapted in many different configurations and devices. The ACT may be incorporated into a stand-alone device (ACD) or adapted to cellular phones, PDA's, laptops wristwatches, etc. A clothing tag may also be adapted to incorporate ACT.

An important application would be to adapt “Anonymous Communication Technology” (ACT) to existing and future cellular phone circuitry. This configuration could take advantage of both the large and growing volume of the cellular phone market and of the cellular phones hardware (microphone, speaker, camera optical system for targeting, etc.) and circuitry. The ACD could be designed as an accessory for cellular phones, PDA's, laptops, computers, etc. The ACT accessory would rely on existing ports and interfaces of various devices for easy adaptation.

In addition, land stations, floating buoy stations, etc., may be utilized to access other ACD's by providing additional range and or such stations may be adapted to interface ACT with other existing technologies and means of communication. For example, cellular phones, emergency land lines, 911, etc.

Mobile Stations may also be adapted to automobiles. For example, a passing vehicle may be targeted (by another vehicle or handheld ACD) and the vehicles ACD may be adapted directly into the auto audio system or as a dashboard unit. ACT could be adapted into the cars a vehicle's internal circuitry. Emergency vehicles, police, etc., could target an automobile (or be adapted to target multiple auto's), thus, providing means to communicate with a vehicle's operator without placing themselves in harm's way. The auto may be adapted to incorporate the Beacon antenna on the roof of the auto or on license plate. The beacon may also include more detailed information about the automobile and its status. A light may be adapted to indicate the presence of a willing ACD on a moving target.

The Anonymous Communication Device (ACD) would have many applications as a new communication instrument. Applications include entertainment, romance games (guess who) etc.

Someone walking at the mall (or in a nightclub) could be targeted by a second ACD. Anonymous communication would provide an experience similar to that of Internet Chat Rooms. ACD'S could be handed out to patrons of nightclubs and restaurants (increasing their social experience) and returned when they leave.

As a safety device the ACD may also include land and marine stations that are interfaced into a network of existing communication technologies. Police, GPS, and 911 services may be adapted to such stations. A fee based system in nightclubs, bars, marinas (small craft often do not have radio communication), and other settings may also be adapted to include Anonymous Communication Technology (ACT) services.

The ACT may be adapted to personal computers, thus providing a handheld device allowing communication from PC to PC over the Internet. For example, existing Internet (text), chat or requires a microphone, speaker and the user must be sitting at the PC in order to communicate. With ACT the user may utilize the ACD to communicate with their PC and as long as they remain within the RF. A personal computer card may be adapted to provide a land station and transmit data two ways (PC/ACD) and vice versa.

One embodiment of Anonymous Communication Technology would be a stand alone ACD. The ACD would consist of an optical or an electromechanical targeting system. A targeting system may be electronically controlled using optical lens or a laser pointing system. Once the ACD is pointed at the target, an infrared signal would activate the targeted ACD Beacon, thus, the targeting device will automatically synchronize its radio frequency to that of the targeted device. Light emitting diodes may be adapted to indicate targeting and or communication status. Note: The targeted devices beacon provides the necessary data to accomplish the synchronization of the two devices. Each ACD provides a unique beacon. The beacon may be designed to randomly modulate its beacon signal. The beacon signal may be designed to continuously transmit its data or as a power saver only transmit when the specific ACD is targeted. The ACD may also be designed so that either ACD'S change their respective frequencies when one or the other is targeted. It may be more desirable to have only one device, the targeting or the targeted ACD adjust its frequency when a device is activated.

Once a device is activated and the infrared signal is detected the targeting device will lock onto the targeted device. Utilizing the infrared date the targeting device will synchronize it's radio frequency to that of the targeted devices. Both units would then be able to communicate via RF.

The ACD may include a view screen for targeting and/or for text messaging. A multifunction button, LED's and other tactile interfaces may be adapted to enhance operation experience. If the ACT is incorporated into the cellular phones circuitry, a standby and/or multifunction button would active the ACD/Cellular Phone operations.

For Example, an individual carries the ACD in the standby mode. (The standby mode will activate the beacon signal thus, allowing the ACD to be targeted for communication). The beacon signal may be designed to modulate its frequencies and only transmit the beacon signal when targeted. If a second ACD intended to communicate with you, they would target you with their ACD and send an infrared signal. When the infrared signal is detected either the targeted or targeting ACD will automatically synchronize their respective devices RF transmitter/receivers. The RF communication does not require further targeting and a two-way conversation is possible as long as the two ACD'S remain within RF range. When the two ACD's are communicating the beacon signal is temporarily shut down to prevent other ACD'S from locking on to the in-use ACD. If in a loud environment the ACD'S may use text messaging to communicate. Pre-programmed tactile buttons may also be adapted for specific communication (hello, etc).

To end a two-way conversation either unit may shut down their RF transmitter/receiver by pressing their stop or multifunction button on the ACD thus, returning the ACD to the stand-by mode.

Anonymous Communication Technology may be adapted as stand-alone accessories. The ACD accessories could be designed to receive their power from the mother device. Accessories for laptops, cell phones, PDA's, PC's and automobiles may be adapted to incorporate the Anonymous Communication Technology.

Boats and other floating vessels may also be adapted to incorporate the ACT (Anonymous Communication Technology). Both anonymous and random targeting would provide seagoing vessels communication means for emergency purposes.

Note: If ACT were built into new generation cellular phones the odds of picking up a signal beacon along the coastline would be significantly improved. ACD buoy stations may also be adapted to interface with other existing communication technologies, such as landlines, cable, satellite, cellular etc.

Central networks may be developed to include ACD Marine stations, ACD National Parks, ACD Entertainment Systems, etc.

ACD'S would be inexpensive to produce and easily be adapted to other communication devices like the cellular phone or as an accessory for such devices. ACD'S would create a new form of affordable, anonymous, non-contractual communication. These devices would enhance the overall function of other devices and provide a new emergency system for highway patrol.

### BRIEF DESCRIPTION OF THE DRAWINGS

The foregoing summary, as well as the following detailed description, may be better understood when read in conjunction with the accompanying drawings, which are incorporated in and form a part of the specification. The drawings serve to explain the principles of the invention and illustrate embodiments of the present invention that are preferred at the time the application was filed. It should be understood however that the invention is not limited to the precise arrangements and instrumentalities shown.

FIG. 1 is an FIG. 1 is a perspective view of a stand alone Anonymous Communication Device (AACD).

FIG. 2 is a perspective view of Anonymous Communication Technology adapted to a cellular phone.

FIG. 3 is a respective view of the Anonymous Communication Technology adapted as an accessory for use with cellular phones or PDA'S etc.

FIG. 4 is a respective view of the Anonymous Communication Technology Anonymous Communication Technology adapted to a PC Card.

FIG. 5 is a represented view of the handheld controller adapted to a PC Card.

FIG. 6 represents an Anonymous Communication Device (ACD) attached to a fixed stationary location such as, a Personal Computer (VOIP), highway patrol sign, road sign, and/or highway billboard.

### DETAILED DESCRIPTION OF THE PREFERRED EMBODIMENT

The present invention generally relates to personal communication devices. More specifically, the present invention is an Anonymous Communication Device that utilizes multiple frequencies and wavelengths of the electromagnetic spectrum. The Anonymous Communication Device (hereinafter referred to as “ACD”) utilizes one part of the electromagnetic spectrum for alerting about its presence and physically targeting a second device (in a preferred embodiment using infra red) and uses RF to communicate with the target device, thus providing a personal communication device that has the ability to target, suitably modulate its RF carrier to match the targeted device, lock onto a second device and communicate (with any other device that has ACD technology adapted).

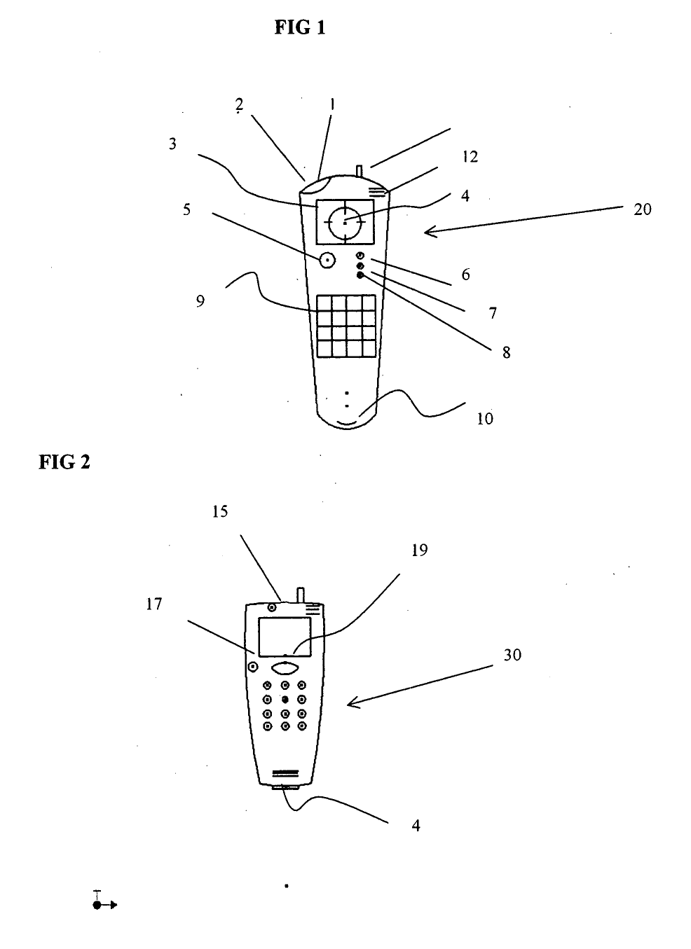

Referring now to FIG. 1, ACD 20 represents a stand alone ACD. To operate, ACD 20 is carried by an individual in the standby mode. The ACD will send a beacon signal by means of its on board IR transmitter/receiver 1. The beacon signal will provide operating specification data including, RF channel frequency etc.

In order to communicate with a second ACD, an individual points the optical lens 2 at the second ACD (individual). View screen 3 may be adapted to help locate and focus onto the desired target. View Screen 3 may include cross airs 4 to pinpoint a target in a crowd. The beacon signals maybe activated when the ACD is targeted, this approach will require less power verses each ACD continuously transmitting their beacon signal.

Multi-function button 5 maybe pressed and held, activating the IR transmitter/receiver 1. Operating status LED's 6 may be adapted to indicate the presence of another ACD Beacon Signal.

When a beacon signal is detected, the Targeting ACD will synchronize its RF specification data to that of the Targeted devices. (Note: The synchronization may work in reverse thus; the Targeted ACD may synchronize its RF specification data to that of the Targeting ACD).

LED 7 may be adapted to indicate communication status (talk mode etc). Button 5 may then be released and a two-way conversation may take place by (RF means) transmitter/receiver 2 and antenna 13. An audio means may be adapted to notify that the ACD is being targeted and/or is in talk mode.

Speaker 12 and microphone 10 may be used for voice communication or keypad 9 may be used for sending text messaging. Either ACD may end the communication at anytime by repressing the multi-function button 5, thus, shutting down the RF signal. (Note: When two-way communication is activated both devices will temporarily deactivate (off) their beacon signal transmitter/receiver) in order to prevent additional ACD's from listening in or interrupting the on going communication.

After each ACD is shut down both ACD'S may be designed to scramble their RF specification data to avoid interference when several devices are present. Also, after shutting down RF communication both units will re-activate (ON) their beacon signal transmitter/receiver.

Referring now to FIG. 2, a preferred embodiment of the Anonymous Communication Technology (ACT) adapted to new generation cellular phones. Incorporating ACT into existing cellular phones would provide an instant network of ACD'S thus, enhancing the enjoyment, functionality of communication devices. The cellular phone application would provide a large network of available ACD'S to be targeted; additionally the application would be economical. The ACD could utilize the cellular phones hardware (keypad, speakers, microphone power supply, optics, etc). ACT would significantly improve the overall experience and functionality of cellular phones. ACT adapted to Cellular phones would be the killer application. {Note: It may be desired that a two-way communication takes place over the cellular network, thus providing a fee based system that the Cellular companies can charge a premium for} For example, the targeting ACD will be charged a fee (the communication link would use the cellular network versus the RF communication providing unlimited range). In this case the beacon signal will provide the cellular access ID or number, thus communicating over the cellular network, with unlimited range.

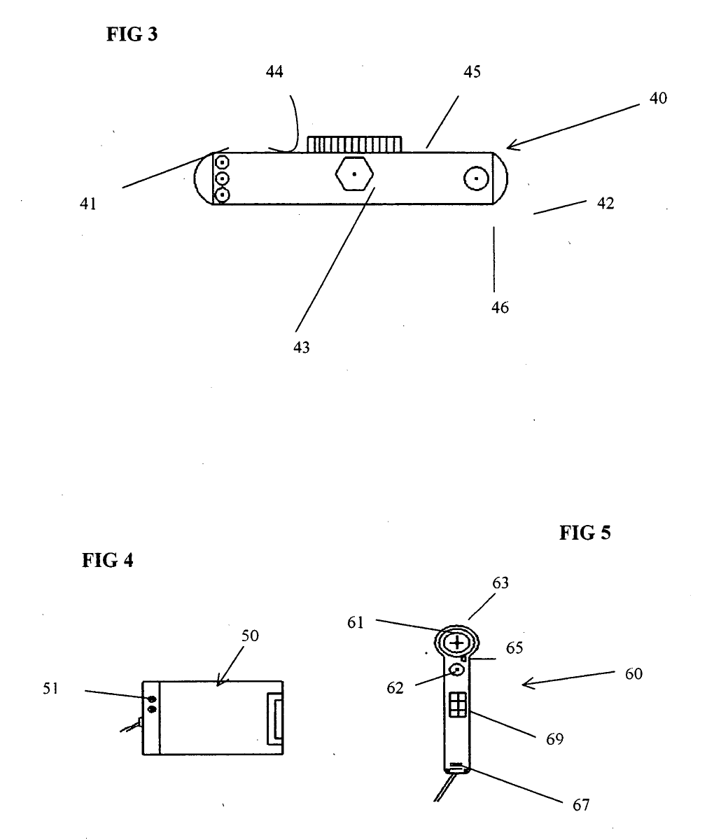

In FIG. 2, cellular phone 30 may include a standby on-off button 15. In the standby mode both the cell phone and the ACD features are active. If either technology is activated, the other remains idle until either the cellular or ACT conversation has ended. In order to activate the ACD technology feature, the user points the cell phones optics at the target. A separate activation button 17 may be adapted to indicate the IR targeting status or a universal multi-function button 19 may be adapted to the phone. Light emitting diodes may also be adapted to indicate the operating status of the ACD. Power Supply Interface 4 is used as an accessory port for a stand-alone ACD accessory as in FIG. 3.

Referring now to FIG. 3, accessory ACD 40 may be adapted to interface with existing cell phones. This feature provides means to adapt existing cellular phones with Anonymous Communication Technology (ACT). ACD accessory 40 is designed to utilize the cellular phones battery charging port interface 45. ACD 40 may receive its power supply from the cellular phone or be designed to have its own internal power supply. ADC 40 may also be designed to utilize the cell phones microphone, speakers, view-screen etc.

Infrared transmitter/receiver 41 is adapted to target a second ACD. RF transmitter/receiver 42, multi-function button 43, and status button 44 are all incorporated to provide ACT. An optical view screen 46 may also be adapted to the ACD accessory 40.

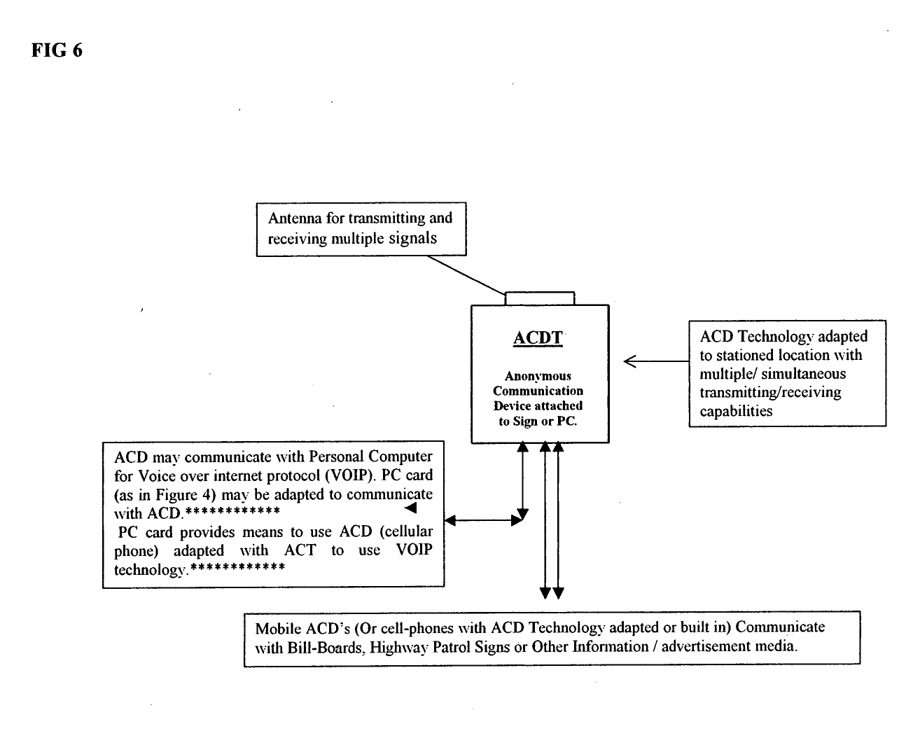

Referring now to FIG. 4 a PC Card 50 adapted to incorporate Anonymous Communication Technology (ACT) to existing PC's, Laptops, PDA's, and/or Digital Cameras to name a few applications. Light emitting diode indicators 51 may be adapted to provide operating status feedback.

FIG. 5, handheld controller 60, includes the means to operate the ACD in FIG. 4 or an on-board automobile ACD, thus, providing two way ACT communications between devices. Targeting mechanism 61 and IR System 62, provide the means to focus onto another ACD or device with ACT capability adapted. Multi-function button 63, operating status button 65 and microphone 67 all provide the input/output features to operate the ACD. A small holding station may be adapted to attach to an automobile dashboard to provide an Automobile ACD Accessory. Keypad 69 may be adapted for text input or quick key programming.

Referring now to FIG. 6, represents an Anonymous Communication Device (ACD) that is attached to a fixed stationary location such as; a PC, a road-sign, billboard, highway patrol sign, or nationwide homeland security system.

FIG. 6 represents an ACD that has the capability of transmitting and receiving multiple signals simultaneously, unlike a handheld or stand alone unit. A passing motorist may point their ACD at such a device (FIG. 6) and transmit or receive up to date information. This information could include advertisements, emergency or general information.

Additionally, a new and soon to be popular technology is referred to as VOIP; there are companies that are manufacturing and marketing phones that are specific for VOIP. Typically, (VOIP) requires a microphone and speaker, and the PC.

By using ACD (technology) the ACD or the cellular phone adapted with ACT (Anonymous Communication Technology) and a PC card (described in FIG. 4 or stationary device described in FIG. 6) replaces the need for a special phone (current technology), and allows the ACD or Cellular Phone with (ACT) to Point, Press and Talk over the internet with their existing phones (via RF communication) as previously described in this invention. Another advantage of this feature is that as long as there is access to a stationary ACDT as in (FIG. 6), either VOIP or Mobile Communication is possible utilizing RF (non-cellular, non-subscription, no fee) communication, or if desired utilizing the cellular fee based network, for example (It may be desired that a two-way communication takes place over the cellular network, thus providing a fee based system that the Cellular companies can charge a premium for} For example, the targeting ACD will be charged a fee (the communication link would use the cellular network versus the RF communication providing unlimited range). In this case the beacon signal will provide the cellular access ID or number, thus communicating over the cellular network, with unlimited range.

ACT allows an ACD (individual) to communicate with another ACD by visual inspection. Neither individual needs to have the email, ID, phone number etc. of the other ACD. Unlike all other technologies including WIFI, ACT allows anonymous communication. Point, Press Talk or Text (PPTT).

A handheld communication device (Anonymous Communication Device) that has means to communicate with other handheld communication devices (AACD) whereby;

Said communication may be intentionally or voluntarily anonymous.

Such device has means to target a second device (does not require knowledge of ID, email, phone number), visual inspection of a desired target is sufficient to communicate with said ACD.

Said device has optical means to target and second device.

Said device has mechanical means to target a second device.

The targeting means rely on Infra red Frequencies.

The targeting means use one part of the electro magnetic spectrum to target a second device and a different part of the EMS to communicate with the second device.

The said device has means to transmit and receive Infrared frequencies.

Said IR frequencies include specification date of said device.

The said device has means to modulate its RF and IR transmissions frequencies.

Said device has means to internally and externally communicate between said devices, IR and RF transmitter/receiver.

Said device has means to automatically synchronize said devices RF (frequency) to second, said devices RF (frequency).

Said device has means to transmit and receive a beacon signal.

The said device has means to anonymously communicate with other said devices.

The said devices use more than one part of the electromagnet spectrum to communicate.

The said device does not require a phone number or email address in order to access a second device (Point and Press Technology).

The said device (ACD) has means to transmit and receive RF.

Said device utilizes more than one part of the electromagnetic spectrum to anonymously communicate to a second (ACD) device.

The said device has means to transmit and receive a beacon signal from other such devices.

Said device may modulate its transmitter and receiver to automatically synchronize and lock onto another specific desired said device.

Anonymous Communication Technology has means to adapt to other communication devices.

Said device provides means to adapt to land, sea and mobile stations. Such station may interface ACT with other existing communication technologies.

Automobiles may be adapted to incorporate ACT.

ACT has means to adapt to cellular phones, PDA'S, laptops, digital cameras, telescope, binoculars, auto, clothing tags etc.

ACD land stations have means to increase RF range.

ACD'S may be adapted to highway billboards and road signs (thus, providing information, related to advertising, highway safety, and or homeland security systems).

Said device has means to communicate through voice and text.

Said device may be adapted as an accessory to interface with other typical communication devices (PC Card, PDA Card, PC enabled VOIP, cellular phone accessory etc).

Said device may be disposable.

Said device may be adapted to clothing (Tag).

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

1. A wireless communication system comprising:
a first communication device that can output an initial wireless signal, said initial output signal includes information regarding available frequencies; and
a second communication device that can anonymously (without identifying indicia) receive said initial output signal from the first communication device and will return a responsive signal (the initial output signal and responsive signal referred to as hard shaking) to establish a communication link between said communication devices over any available frequency.

2. The wireless communication system of claim 1, wherein if the communication link deteriorates, said devices will retransmit initiating signals by dynamically renegotiating the communication link in order to establish a new communication link.

3. The wireless communication system of claim 1 wherein the initial output signal is an infrared signal.

4. The wireless communication system of claim 3 wherein said first communication device targets said second communication device visually (i.e., line-of-sight) using optical or mechanical targeting means.

5. The wireless communication system of claim 4 further comprising a notification means integrated into each communication device that conveys to a user that targeting has been achieved (e.g., cross-hairs appear on an LCD screen).

6. The wireless communication system of claim 4 wherein the communication link is established over a radio frequency channel.

7. The wireless communication system according to claim 6 wherein each of said communication devices can be incorporated into a cellular telephone and said communication link can be established using exiting cellular telephone technology.

8. The wireless communication system of claim 4 wherein said system determines the best frequency over which to communicate and establishes said link over said best frequency.

9. The wireless communication system of claim 8 wherein said system determines the best modulation scheme ever which to communicate and said established link utilizes said modulation scheme.

10. The wireless communication system of claim 1 wherein said communication link is encrypted to prevent interference from third party communication devices and to prevent third party communication devices from eavesdropping.

11. The wireless communication system of claim 1, wherein inputs from users of each communication device can be voice or text messaging.

12. The wireless communication system according to claim 1 wherein said first communication device is a stand-alone unit and said second communication device is incorporated into a PC card for use in a personal computer.

13. The wireless communication system of claim 12 wherein said system utilizes any type of computer-to-computer communication including instant messaging, chat rooms, and voice-over-internet-protocol.

14. The wireless communication system of claim 1 wherein once said communication link is established, said handshaking circuitry is temporarily disabled thereby preventing a third party from interrupting the communication between said first and second communication devices.

15. A wireless communication system comprising:
a first communication device having at least one transmitter and at least one receiver;
a second communication device having at least one transmitter and at least one receiver;
means for activating said transmitter on either communication to generate a beacon signal while simultaneously targeting the other communication device to anonymously initiate a handshaking protocol, said handshaking protocol includes information to establish a permanent communication link between said two communication devices including a choice of RF carrier and type of modulation.

16. The wireless communication system of claim 15 wherein said first communication device is mounted on a motor vehicle and said second communication device is mounted on a billboard said second communication device being capable of handling multiple communication links.

17. The wireless communication system of claim 15 wherein said first communication device is mounted on a first motor vehicle and said second communication device is mounted on an emergency vehicle, said second communication device can send signals to warn other communication devices.

18. The wireless communication system of claim 15 wherein each communication device has at least two transmitters and at least two receivers, one of said at least two transmitters being capable of transmitting infrared signals and the other of said at least two transmitters being capable of transmitting RF signals, one of said at least two receivers being capable of receiving infrared signals and the other of said at least two receivers being capable of receiving RF signals, wherein said handshaking protocol is handled by said infrared transmitters/receivers and said communication link is handled by mid RF transmitters/receivers.
